(19) United States
(12) Patent Application Publication
(10) Pub. No.: US 2018/0346642 A1
(43) Pub. Date: Dec. 6, 2018

(54) LIQUID CRYSTAL POLYESTER COMPOSITION, MOLDED BODY, AND CONNECTOR

(71) Applicant: Sumitomo Chemical Company, Limited, Tokyo (JP)

(72) Inventor: Hiromitsu HEGI, Tsukuba-shi, Ibaraki (JP)

(21) Appl. No.: 15/761,652

(22) PCT Filed: Sep. 23, 2016
(86) PCT No.: PCT/JP2016/077995

§ 371 Date: Mar. 20, 2018

(30) Foreign Application Priority Data
Sep. 25, 2015 (JP) 2015-187546

(51) Int. Cl. C08G 63/60; C08K 3/34; C08K 7/00; H01R 13/50; H01R 43/18

(52) U.S. Cl. CPC C08G 63/605; C08K 3/34; C08K 7/00; C08K 2003/343; H01R 43/18; C08G 2250/00; H01R 13/50

(57) ABSTRACT

A liquid crystal polyester composition which includes liquid crystal polyester and a plate-like inorganic filler is provided. The ratio of signal strength of iron with respect to signal strength of silicon in the plate-like inorganic filler is 1 to 2.5, in a case where a signal of a component included in the plate-like inorganic filler is detected and strength of the signal is acquired for each component by X-ray fluorometry. A molded body obtained by molding the liquid crystal polyester composition and a connector obtained by molding the liquid crystal polyester composition are also provided. The molded body has high bending strength.

### TECHNICAL FIELD

The present invention relates to a liquid crystal polyester composition, and a molded body and a connector obtained by molding the same.

Priority is claimed on Japanese Patent Application No. 2015-187546, filed on Sep. 25, 2015, the content of which is incorporated herein by reference.

### BACKGROUND ART

Since liquid crystal polyester has excellent melt fluidity and high heat resistance or strength and rigidity, the liquid crystal polyester is suitably used as an injection molding material for manufacturing electrical and electronic equipment and is suitable for manufacturing a connector and the like, for example. However, a molecular chain of the liquid crystal polyester is easily oriented in a flow direction at the time of the molding, and thus, anisotropy of a coefficient of contraction and a coefficient of expansion or mechanical properties may easily occur. In order to solve such problems, studies have been carried out regarding injection molding performed by using a liquid crystal polyester composition obtained by mixing mica into liquid crystal polyester.

### CITATION LIST

### Patent Literature

[Patent Document 1] Japanese Unexamined Patent Application, First Publication No. H3-167252

### SUMMARY OF INVENTION

### Technical Problem

However, although a liquid crystal polyester composition of the related art including the liquid crystal polyester described above and a plate-like inorganic filler such as mica has provided a molded body in which occurrence of anisotropy was prevented, the bending strength of the molded body was not sufficient.

The invention is made in consideration of these circumstances and an object thereof is to provide a liquid crystal polyester composition which includes liquid crystal polyester and a plate-like inorganic filler and provides a molded body having high bending strength, and a molded body obtained by molding the liquid crystal polyester composition.

### Solution to Problem

In order to solve the aforementioned problems, the following configurations are used in the present invention.

[1] A liquid crystal polyester composition including: liquid crystal polyester; and a plate-like inorganic filler, in which the ratio of signal strength of iron with respect to signal strength of silicon in the plate-like inorganic filler is 1 to 2.5, in a case where a signal of a component included in the plate-like inorganic filler is detected and strength of the signal is acquired for each component by X-ray fluorometry.

[2] The liquid crystal polyester composition according to [1], in which the amount of the plate-like inorganic filler is 10 to 250 parts by mass with respect to 100 parts by mass of the amount of the liquid crystal polyester.

[3] The liquid crystal polyester composition according to [1] or [2], in which the ratio of signal strength of titanium with respect to the signal strength of silicon in the plate-like inorganic filler is 0 to 0.08.

[4] The liquid crystal polyester composition according to any one of [1] to [3], in which the ratio of signal strength of calcium with respect to the signal strength of silicon in the plate-like inorganic filler is 0 to 0.003.

[5] The liquid crystal polyester composition according to any one of [1] to [4], in which the plate-like inorganic filler is mica.

[6] The liquid crystal polyester composition according to an one of [1] to [5], in which the liquid crystal polyester includes a repeating unit represented by General Formula (1), a repeating unit represented by General Formula (2), and a repeating unit represented by General Formula (3).

—O—Ar¹—CO— (1)

—CO—Ar²—CO— (2)

—X—Ar³—Y— (3)

[in Formulae (1) to (3), Ar¹ represents one of the group consisting of a phenylene group, a naphthylene group, and a biphenylylene group, Ar² and Ar³ each independently represent one of the group consisting of a phenylene group, a naphthylene group, a biphenylylene group, and a group represented by General Formula (4), X and Y each independently represent one of the group consisting of an oxygen atom and an imino group, one or more hydrogen atoms in the group represented by one of the group consisting of Ar¹, Ar², and Ar³ may be each independently substituted with one of the group consisting of a halogen atom, an alkyl group having 1 to 28 carbon atoms, and an aryl group having 6 to 12 carbon atoms]

—Ar⁴—Z—Ar⁵— (4)

[in Formula (4), Ar⁴ and Ar⁵ each independently represent one of the group consisting of a phenylene group and a naphthylene group, and Z represents one of the group consisting of an oxygen atom, a sulfur atom, a carbonyl group, a sulfonyl group, and an alkylidene group having 1 to 28 carbon atoms.]

[7] A molded body obtained by molding the liquid crystal polyester composition according to any one of [1] to [6].

[8] A connector obtained by molding the liquid crystal polyester composition according to any one of [1] to [6].

[9] A manufacturing method of a molded body including: molding the liquid crystal polyester composition according to any one of [1] to [6] to obtain a molded body of liquid crystal polyester.

[10] A manufacturing method of a connector including: molding the liquid crystal polyester composition according to any one of [1] to [6] to obtain a connector.

### Advantageous Effects of Invention

According to the present invention, a liquid crystal polyester composition which includes liquid crystal polyester and a plate-like inorganic filler and provides a molded body having high bending strength, a molded body obtained by molding the liquid crystal polyester composition, and a connector obtained by molding the liquid crystal polyester composition.

### BRIEF DESCRIPTION OF DRAWINGS

FIG. 1 is a perspective view schematically showing a connector of an embodiment of the invention.

FIG. 2 is an enlarged front view showing main parts of the connector shown in FIG. 1.

### DESCRIPTION OF EMBODIMENTS

Hereinafter, suitable embodiments of the invention will be described.

<Liquid Crystal Polyester Composition>

A liquid crystal polyester composition of the embodiment is a liquid crystal polyester composition which includes liquid crystal polyester, and a plate-like inorganic filler, and in which the ratio of signal strength of iron with respect to signal strength of silicon in the plate-like inorganic filler is 1 to 2.5, in a case where a signal of a component included in the plate-like inorganic filler is detected and strength of the signal is acquired for each component by X-ray fluorometry.

In a case of considering the amount of the plate-like inorganic filler used in a case of obtaining a molded body, a plate-like inorganic filler including silicon and iron satisfying the relationship described above is used as the plate-like inorganic filler in the liquid crystal polyester composition of the present invention. In this case, it is possible to obtain a molded body having high bending strength. As will be described later, a proportional relationship is formed between strength of a fluorescence X-ray signal of a component (element) detected by X-ray fluorometry and an amount of the component in the plate-like inorganic filler, and the detected component has quantitativity, and thus, the ratio of silicon and iron in the plate-like inorganic filler is in a specific range. The embodiment is made in view of fact that bending strength of a molded body obtained by using the plate-like inorganic filler including silicon fluctuates even in a case where a plate-like inorganic filler having similar size and composition is used, the reason of this fluctuation is due to a variation in amount of a specific component included in the plate-like inorganic filler, and the specific component is mainly iron.

[Liquid Crystal Polyester]

The liquid crystal polyester is liquid crystal polyester showing liquid crystalline properties in a melted state. The liquid crystal polyester preferably melts at a temperature equal to or lower than 450° C. The liquid crystal polyester may be liquid crystal polyester amide, may be liquid crystal polyester ether, may be liquid crystal polyester carbonate, or may be liquid crystal polyester imide. The liquid crystal polyester is preferably wholly aromatic liquid crystal polyester obtained by using only aromatic compounds as a raw material monomer.

Typical examples of the liquid crystal polyester include a material obtained by condensation polymerization of aromatic hydroxycarboxylic acid, aromatic dicarboxylic acid, and at least one compound selected from the group consisting of aromatic diol, aromatic hydroxylamine, and aromatic diamine, a material obtained by polymerization of plural kinds of aromatic hydroxycarboxylic acid, a material obtained by polymerization of aromatic dicarboxylic acid and at least one compound selected from the group consisting of aromatic diol, aromatic hydroxyamine, and aromatic diamine, and a material obtained by polymerization of polyester such as polyethylene terephthalate and aromatic hydroxycarboxylic acid. Here, regarding aromatic hydroxycarboxylic acid, aromatic dicarboxylic acid, aromatic diol, aromatic hydroxyamine, and aromatic diamine, polymerizable derivatives thereof may be each independently used instead of a part or the entire part thereof.

Examples of a polymerizable derivative of a compound including a carboxyl group such as aromatic hydroxycarboxylic acid and aromatic dicarboxylic acid include a material obtained by converting a carboxyl group into an alkoxycarbonyl group or an aryloxycarbonyl group (ester), a material obtained by converting a carboxyl group into a haloformyl group (acid halide), and a material obtained by converting a carboxyl group into a an acyloxycarbonyl group (acid anhydride). As an example of a polymerizable derivative of a compound including a hydroxyl group such as aromatic hydroxycarboxylic acid, aromatic diol, or aromatic hydroxyamine, a material obtained by acylating a hydroxyl group to convert it into an acyloxy group (acylated product) is used. As an example of a polymerizable derivative of a compound including an amino group such as aromatic hydroxylamine and aromatic diamine, a material obtained by acylating an amino group to convert it into an acylamino group (acylated product) is used.

The liquid crystal polyester preferably includes a repeating unit represented by General Formula (1) (hereinafter, may be referred to as a “repeating unit (1)”), and more preferably includes the repeating unit (1), a repeating unit represented by General Formula (2) (hereinafter, may be referred to as a “repeating unit (2)”), and a repeating unit represented by General Formula (3) (hereinafter, may be referred to as a “repeating unit (3)”).

—O—Ar¹—CO— (1)

—CO—Ar²—CO— (2)

—X—Ar³—Y— (3)

[In Formulae (1) to (3), Ar¹ represents a phenylene group, a naphthylene group, or a biphenylylene group. Ar² and Ar³ each independently represent a phenylene group, a naphthylene group, a biphenylylene group, or a group represented by General Formula (4). X and Y each independently represent one of the group consisting of an oxygen atom and an imino group (—NH—). One or more hydrogen atoms in the group represented by Ar¹, Ar², or Ar³ may be each independently substituted with one of the group consisting of a halogen atom, an alkyl group having 1 to 28 carbon atoms, and an aryl group having 6 to 12 carbon atoms.]

—Ar⁴—Z—Ar⁵— (4)

[In Formula (4), Ar⁴ and Ar⁵ each independently represent one of the group consisting of a phenylene group and a naphthylene group. Z represents one of the group consisting of an oxygen atom, a sulfur atom, a carbonyl group, a sulfonyl group, and an alkylidene group having 1 to 28 carbon atoms.]

Examples of the halogen atom which can be substituted with a hydrogen atom include a fluorine atom, a chlorine atom, a bromine atom and an iodine atom.

Examples of the alkyl group having 1 to 28 carbon atoms which can be substituted with a hydrogen atom include a methyl group, an ethyl group, an n-propyl group, an isopropyl group, an n-butyl group, an isobutyl group, a sec-butyl group, a tert-butyl group, an n-hexyl group, a 2-ethylhexyl group, an n-octyl group, and an n-decyl group. The number of carbon atoms in the alkyl group is preferably 1 to 10.

Examples of the aryl group having 6 to 12 carbon atoms which can be substituted with a hydrogen atom include a monocyclic aromatic group such as a phenyl group, an o-tolyl group, an m-tolyl group, or a p-tolyl group, and a condensed aromatic group such as a 1-naphthyl group or a 2-naphthyl group.

In a case where one or more hydrogen atoms in the group represented by Ar¹, Ar², or Ar³ are substituted with these groups, the number of substitution is preferably 1 or 2 for each group represented by Ar¹, Ar², or Ar³, each independently, and more preferably 1.

Examples of the alkylidene group having 1 to 28 carbon atoms include a methylene group, an ethylidene group, an isopropylidene group, an n-butylidene group, or a 2-ethylhexylidene group. The number of carbon atoms in the alkylidene group is preferably 1 to 10.

The repeating unit (1) is a repeating unit derived from predetermined aromatic hydroxycarboxylic acid.

As the repeating unit (1), a repeating unit in which Ar¹ is a 1,4-phenylene group (repeating unit derived from p-hydroxybenzoic acid), or a repeating unit in which Ar¹ is a 2,6-naphthylene group (repeating unit derived from 6-hydroxy-2-naphthoic acid) is preferable.

The repeating unit (2) is a repeating unit derived from predetermined aromatic dicarboxylic acid.

As the repeating unit (2), a repeating unit in which Ar² is a 1,4-phenylene group (repeating unit derived from terephthalic acid), a repeating unit in which Ar² is a 1,3-phenylene group (repeating unit derived from isophthalic acid), a repeating unit in which Ar² is a 2,6-naphthylene group (repeating unit derived from 2,6-naphthalenedicarboxylic acid), or a repeating unit in which Ar² is a diphenyl ether-4,4′-diyl group (repeating unit derived from diphenyl ether-4,4′-dicarboxylic acid) is preferable.

The repeating unit (3) is a repeating unit derived from predetermined aromatic diol, aromatic hydroxyamine or aromatic diamine.

As the repeating unit (3), a repeating unit in which Ar³ is a 1,4-phenylene group (repeating unit derived from hydroquinone, p-aminophenol or p-phenylenediamine), or a repeating unit in which Ar³ is a 4,4′-biphenylylene group (repeating unit derived from 4,4′-dihydroxybiphenyl, 4-amino-4′-hydroxybiphenyl, or 4,4′-diaminobiphenyl) is preferable.

The amount of the repeating unit (1) in the liquid crystal polyester is preferably equal to or greater than 30 mol %, more preferably 30 to 80 mol %, even more preferably 40 to 70 mol %, and particularly preferably 45 to 65 mol % with respect to a total amount of all of the repeating units constituting the liquid crystal polyester (value obtained by adding up the substance amount equivalent (mol) of each repeating unit, which is obtained by dividing mass of each repeating unit configuring the liquid crystal polyester by formula weight of each repeating unit).

In the liquid crystal polyester, as the amount of the repeating unit (1) is great, melt fluidity, heat resistance, and strength and rigidity are easily improved. In a case where the amount thereof is excessively great, for example, in a case where the amount thereof exceeds 80 mol %, a temperature necessary for molding easily increases.

The amount of the repeating unit (2) in the liquid crystal polyester is preferably equal to or smaller than 35 mol %, more preferably 10 to 35 mol %, even more preferably 15 to 30 mol %, and particularly preferably 17.5 to 27.5 mol % with respect to the total amount of all of the repeating units constituting the liquid crystal polyester.

The amount of the repeating unit (3) in the liquid crystal polyester is preferably equal to or smaller than 35 mol %, more preferably 10 to 35 mol %, even more preferably 15 to 30 mol %, and particularly preferably 17.5 to 27.5 mol % with respect to the total amount of all of the repeating units constituting the liquid crystal polyester.

In the liquid crystal polyester, the ratio of the amount of the repeating unit (2) and the amount of the repeating unit (3) is shown as [amount of the repeating unit (2)]/[amount of the repeating unit (3)] (mol/mol), and is preferably 0.9/1 to 1/0.9, more preferably 0.95/1 to 1/0.95, and even more preferably 0.98/1 to 1/0.98.

The liquid crystal polyesters may include one kind or two or more kinds of the repeating units (1) to (3) each independently. The liquid crystal polyester may include one kind or two or more kinds of a repeating unit other than the repeating units (1), (2), and (3), and the amount thereof is preferably 0 to 10 mol % and more preferably 0 to 5 mol % with respect to the total amount of all of the repeating units.

The liquid crystal polyester preferably includes a repeating unit in which X and Y each represent an oxygen atom as the repeating unit (3). To include a repeating unit in which X and Y each include an oxygen atom as the repeating unit (3) is to include a repeating unit derived from predetermined aromatic diol. This configuration is preferable because melt viscosity of the liquid crystal polyester easily decreases. It is more preferable that only a repeating unit in which X and Y each represent an oxygen atom is included as the repeating unit (3).

The liquid crystal polyester is preferably manufactured by causing melt polymerization of a raw material monomer corresponding to the repeating unit configuring the liquid crystal polyester, and causing solid-state polymerization of the obtained polymer (hereinafter, may be referred to as a “prepolymer”). Accordingly, it is possible to manufacture high-molecular weight liquid crystal polyester having high heat resistance, strength, and rigidity with excellent operability. The melt polymerization may be performed under the presence of a catalyst, and examples of the catalyst include a metal compound such as magnesium acetate, stannous acetate, tetrabutyl titanate, lead acetate, sodium acetate, potassium acetate, or antimony trioxide, and a nitrogen-containing heterocyclic compound such as 4-(dimethylamino) pyridine or 1-methylimidazole. As the catalyst, the nitrogen-containing heterocyclic compound is preferable.

A flow start temperature of the liquid crystal polyester defined below is preferably equal to or higher than 270° C., more preferably 270° C. to 400° C., and even more preferably 280° C. to 400° C. As the flow start temperature is high, heat resistance or strength and rigidity of the liquid crystal polyester are easily improved, and thus, the flow start temperature is preferably equal to or higher than 270° C. In a case where the flow start temperature is excessively high, for example, in a case where the flow start temperature exceeds 400° C., thermal deterioration easily occurs at the time of molding due to necessity of a high temperature for the melting, or fluidity is deteriorated due to an increase in viscosity at the time of melting.

The flow start temperature is also referred to as a flow temperature, is a temperature indicating a viscosity of 4,800 Pa·s (48,000 poise), in a case where liquid crystal polyester is melted while increasing the temperature at a rate of 4° C./min under a load of 9.8 MPa (100 kg/cm²) by using a capillary rheometer and extracted from a nozzle having an inner diameter of 1 mm and a length of 10 mm, and is a measure of molecular weight of the liquid crystal polyester (see “Liquid Crystal Polymers-Synthesis and Molding and Applications-”, edited by Naoyuki Koide, CMC Publishing Co., Ltd., Jun. 5, 1987, p. 95).

The liquid crystal polyester included in the liquid crystal polyester composition may be one kind or two or more kinds.

In a case where the liquid crystal polyester composition includes two or more kinds of liquid crystal polyesters, it is preferable to include at least liquid crystal polyester (A) and liquid crystal polyester (B) having different flow start temperatures.

A flow start temperature of the liquid crystal polyester (A) is preferably 310° C. to 400° C., more preferably 320° C. to 400° C., and even more preferably 330° C. to 400° C. By setting the flow start temperature to be equal to or higher than the lower limit, heat resistance of the liquid crystal polyester (A) further increases.

The flow start temperature of the liquid crystal polyester (B) is preferably 270° C. to 370° C., more preferably 280° C. to 370° C., and even more preferably 300° C. to 370° C. By setting the flow start temperature to be equal to or higher than the lower limit, the heat resistance of the liquid crystal polyester (B) further increases.

A difference between the flow start temperature of the liquid crystal polyester (A) and the flow start temperature of the liquid crystal polyester (B) is preferably 10° C. to 60° C., more preferably 20° C. to 60° C., and even more preferably 25° C. to 60° C. By setting the difference between the flow start temperatures to be in such a range, thin-wall fluidity of the liquid crystal polyester composition further increases, and the molding workability is also further improved.

The amount of the liquid crystal polyester (B) in the liquid crystal polyester composition is preferably 10 to 200 parts by mass, more preferably 10 to 150 parts by mass, and even more preferably 10 to 120 parts by mass with respect to 100 parts by mass of the amount of the liquid crystal polyester (A). By setting the amount of the liquid crystal polyester (B) to be in such a range, thin-wall fluidity of the liquid crystal polyester composition further increases, and the molding workability is also further improved.

In a case where the liquid crystal polyester composition includes any one or both of the liquid crystal polyester (A) and the liquid crystal polyester (B), the liquid crystal polyester composition may include or may not include liquid crystal polyester other than those. It is more preferable that the liquid crystal polyester other than the liquid crystal polyester (A) and the liquid crystal polyester (B) is not included.

For example, in a case where the liquid crystal polyester composition includes any one or both of the liquid crystal polyester (A) and the liquid crystal polyester (B), both the liquid crystal polyester (A) and the liquid crystal polyester (B) may be one kind or two or more kinds. The liquid crystal polyester other than the liquid crystal polyester (A) and the liquid crystal polyester (B), included in the liquid crystal polyester composition may also be one or two or more kinds of polyester.

[Plate-Like Inorganic Filler]

The plate-like inorganic filler includes silicon and iron, and the contents thereof satisfy specific conditions. That is, in a case where a signal of a component included in the plate-like inorganic filler is detected and strength of the signal is acquired for each component by X-ray fluorometry, the ratio of signal strength of iron with respect to signal strength of silicon ([signal strength of iron]/[signal strength of silicon], hereinafter, may be referred to as “Fe/Si ratio”) in the plate-like inorganic filler is 1 to 2.5. By setting the Fe/Si ratio to be in such a range, the bending strength of a molded body obtained by molding the liquid crystal polyester composition sufficiently increases.

From a viewpoint of further increasing the effect, the Fe/Si ratio of the plate-like inorganic filler is preferably 1 to 2, more preferably 1 to 1.85, and even more preferably 1 to 1.75.

As described above, in a case where the strength of the signal of the component included in the plate-like inorganic filler is acquired by X-ray fluorometry, the ratio of signal strength of titanium with respect to the signal strength of silicon ([signal strength of titanium]/[signal strength of silicon], hereinafter, may be referred to as “Ti/Si ratio”) in the plate-like inorganic filler is preferably 0 to 0.08 and more preferably 0 to 0.07. By setting the Ti/Si ratio to be in such a range, bending strength of a molded body obtained by molding the liquid crystal polyester composition further increases.

As described above, in a case where the strength of the signal of the component included in the plate-like inorganic filler is acquired by X-ray fluorometry, the ratio of signal strength of calcium with respect to the signal strength of silicon ([signal strength of calcium]/[signal strength of silicon], hereinafter, may be referred to as “Ca/Si ratio”) in the plate-like inorganic filler is preferably 0 to 0.003 and more preferably 0 to 0.001. By setting the Ti/Si ratio to be in such a range, soldering heat resistance of a molded body obtained by molding the liquid crystal polyester composition is improved, and more preferable properties as the molded body are provided.

In the liquid crystal polyester composition, it is preferable that any one or both of the Ti/Si ratio and the Ca/Si ratio are in the numerical value ranges described above, in addition to the Fe/Si ratio, and it is more preferable that all of the Fe/Si ratio, the Ti/Si ratio, and the Ca/Si ratio are in the numerical value ranges described above.

In a case of determining availability of usage of the plate-like inorganic filler based on the amount of a specific component included therein, the amount of a target component in the plate-like inorganic filler is normally acquired. Then, a calibration curve of the target component is normally prepared in advance, detection of the target component in the plate-like inorganic filler is performed, and the amount of the target component in the plate-like inorganic filler may be acquired by using the calibration curve and a detected actual measurement value of the target component.

In the embodiment, the following method is preferably used. In a case where the plate-like inorganic filler is provided for X-ray fluorometry, a proportional relationship is formed between strength of a fluorescence X-ray signal of the detected component (element) and the amount of the component in the plate-like inorganic filler, and the detected component has quantitativity. Accordingly, as described above, the ratio of signal strengths of the target component in a case where the X-ray fluorometry is performed, and a component to be reference (silicon) is acquired, information regarding the amount of the target component is acquired without using a calibration curve, and the availability of the usage of the plate-like inorganic filler is determined based on this information. Thus, the operation is simplified, and a possibility of erroneous determination can be decreased, compared to a case where the content is acquired by preparing the calibration curve described above. By using this method of the embodiment, complexity of the operation due to preparation of the calibration curve and the like, a possibility of a decrease in calculation accuracy of the amount of the target component, and the possibility of an erroneous determination decreases.

The detection of the fluorescence X-ray signals of silicon, iron, titanium, calcium included in the plate-like inorganic filler may be performed by a well-known method. For example, regarding these components (elements), Kα rays unique to these components are preferably detected.

The fluorescence X-ray signals of silicon, iron, titanium, and calcium included in the plate-like inorganic filler may be detected, for example, under the same conditions, may be detected under conditions, all of which are different from each other, or may be detected under the conditions, only some of which are the same as each other. In a case of performing the detection under the same conditions, the fluorescence X-ray signals of silicon, iron, titanium, and calcium can be detected at the same time, and thus, the operation can significantly become efficient. Meanwhile, in a case of performing the detection under the conditions, at least some of which are the same as each other, the fluorescence X-ray signals of the target components of silicon, iron, titanium, and calcium can be detected in a state where the strengths thereof are sufficiently great (for example, in a state where the strengths thereof are maximized), and thus, it is possible to improve detection accuracy. In the embodiment, from a viewpoint of improving the detection accuracy, the strengths of the fluorescence X-ray signals of the target components of silicon, iron, titanium, calcium are preferably detected under the conditions set for each component (element), so that the signal strengths thereof sufficiently become great (particularly preferably, the signal strengths thereof is maximized).

The output of an X-ray tube which is an X-ray source is an important example of the condition to be adjusted in order to sufficiently increase the strengths of the fluorescence X-ray signals of the target components of silicon, iron, titanium, and calcium.

The output of the X-ray tube may be selected based on a value recommended in an X-ray fluorescence spectrometer used, and a typical example is as follows.

That is, the output of the X-ray tube in a case of detecting a Kα ray of silicon and a Kα ray of calcium is preferably, for example, 32 kV/125 mA.

The output of the X-ray tube in a case of detecting a Kα ray of iron is preferably, for example, 60 kV/66 mA.

The output of the X-ray tube in a case of detecting a Kα ray of titanium is preferably, for example, 40 kV/100 mA.

The plate-like inorganic filler is not particularly limited as long as the conditions described above are satisfied, and examples thereof include mica, graphite, wollastonite, glass flake, barium sulfate, and calcium carbonate. Mica may be muscovite, phlogopite, fluorophlogopite, or tetrasilicic mica.

The plate-like inorganic filler may be used alone or in combination of two or more kinds thereof.

Among the examples described above, the plate-like inorganic filler is preferably mica.

The amount of the plate-like inorganic filler in the liquid crystal polyester composition is preferably 10 to 250 parts by mass, more preferably 20 to 200 parts by mass, even more preferably 20 to 150 parts by mass, and particularly preferably 30 to 100 parts by mass with respect to 100 parts by mass of the amount of the liquid crystal polyester. By setting the amount of the plate-like inorganic filler to be in such a range, bending strength of a molded body obtained by molding the liquid crystal polyester composition further increases.

In addition, the amount of the plate-like inorganic filler is preferably 3 to 250 parts by mass with respect to 100 parts by mass of the other composition of the liquid crystal polyester composition.

(Other Components)

The liquid crystal polyester composition may include components other than the liquid crystal polyester and the plate-like inorganic filler.

Examples of the other components include inorganic fillers other than the plate-like inorganic filler and additives.

The other components may be included alone or in combination of two or more kinds thereof.

Examples of the inorganic fillers other than the plate-like inorganic filler include a fibrous inorganic filler and a particulate inorganic filler.

Examples of the fibrous inorganic filler include a glass fiber; a carbon fiber such as a pan-based carbon fiber or a pitch-based carbon fiber; a ceramic fiber such as a silica fiber, an alumina fiber, or a silica alumina fiber; and a metal fiber such as a stainless steel fiber. Examples of the fibrous inorganic filler include whiskers such as potassium titanate whiskers, barium titanate whiskers, wollastonite whiskers, aluminum borate whiskers, silicon nitride whiskers, and silicon carbide whiskers.

Examples of the particulate inorganic filler include silica, alumina, titanium oxide, glass beads, a glass balloon, boron nitride, silicon carbide, and calcium carbonate.

In the liquid crystal polyester composition, the amount of the inorganic fillers other than the plate-like inorganic filler is preferably 0 to 150 parts by mass with respect to 100 parts by mass of the amount of the liquid crystal polyester.

Examples of the additives include an antioxidant, a thermal stabilizer, an ultraviolet absorber, an antistatic agent, a surfactant, a flame retardant, and a colorant.

The amount of the additives in the liquid crystal polyester composition is preferably 0 to 5 parts by mass with respect to 100 parts by mass of the amount of the liquid crystal polyester.

The liquid crystal polyester composition is obtained, for example, by mixing the liquid crystal polyester, the plate-like inorganic filler, and the other components, if necessary, collectively or in appropriate order. A mixing method at this time is not particularly limited, and a mixing method using a well-known stirring device such as a tumbler mixer or a Henschel mixer is used.

A pelletized material obtained by melting and kneading of the obtained mixture by using an extruder or the like and extracting the kneaded material in a strand shape may be set as the liquid crystal polyester composition.

An extruder including a cylinder, one or more screws disposed in the cylinder, and one or more supply ports provided in the cylinder is preferable, and an extruder including one or more bend portion in the cylinder is more preferable.

The temperature at the time of melting and kneading is not particularly limited and is preferably 200° C. to 400° C. and more preferably 250° C. to 370° C.

<Molded Body>

The molded body of the embodiment is obtained by molding the liquid crystal polyester composition.

A manufacturing method of the molded body includes molding of the liquid crystal polyester composition. As a method of molding the liquid crystal polyester composition, a melt molding method is preferable, and examples of the melt molding method include an injection molding method; an extrusion molding method such as a T-die method or an inflation method; a compression molding method; a blow molding method; a vacuum molding method; and a press molding method. Among these, the molding method of the composition is preferably the injection molding method.

The molding conditions of the liquid crystal polyester composition are not particularly limited and suitably selected in accordance with the molding method. For example, in a case of performing the molding by the injection molding method, the molding may be performed by setting a cylinder temperature of an injection molding machine to be preferably 250° C. to 400° C. and a die temperature to be preferably 20° C. to 180° C.

The molded body of the embodiment has high bending strength, by using the liquid crystal polyester composition. For example, in a case where a rod-like test piece having a width 12.7 mm, a length of 127 mm, and a thickness of 6.4 mm as will be described later in examples is prepared as the molded body of the embodiment, the bending strength of the test piece in a case where a bending test is performed based on ASTM D790 is preferably equal to or greater than 120 MPa, more preferably equal to or greater than 125 MPa, and even more preferably equal to or greater than 130 MPa.

The molded body of the embodiment has high heat resistance by selecting the type of liquid crystal polyester, for example. For example, in a case a rod-like test piece having a width 6.4 mm, a length of 127 mm, and a thickness of 12.7 mm as will be described later in examples is prepared as the molded body of the embodiment, a deflection temperature under load of the test piece in a case where the measurement is performed under the conditions of a load of 1.82 MPa and the rate of a temperature increase of 2° C./min based on ASTM D648 is preferably equal to or higher than 230° C., more preferably equal to or higher than 234° C., and can also be, for example, equal to or higher than 270° C. or equal to or higher than 280° C.

The molded body of the embodiment has, for example, high soldering heat resistance by selecting the type of the liquid crystal polyester. For example, in a case where JIS K7113 (½) type dumbbell test pieces (thickness of 1.2 mm) which will be described later in examples are prepared as the molded body of the embodiment, 10 test pieces are dipped in a solder bath heated to 270° C. for 60 seconds and extracted, surfaces of these 10 test pieces are visually observed, and the number of test pieces having surfaces, where blisters are observed, is counted, the number is preferably equal to or smaller than 4 and more preferably equal to or smaller than 3.

Examples of a product, equipment, a component or a member configured with the molded body of the embodiment include a bobbin such as an optical pickup bobbin or a transformer bobbin; a relay component such as a relay case, a relay base, a relay sprue, or a relay armature; a connector such as a RIMM, a DDR, a CPU socket, a S/O, a DIMM, a Board-to-Board connector, an FPC connector, or a card connector; a reflector such as a lamp reflector or an LED reflector; a holder such as a lamp holder or a heater holder; a diaphragm such as a speaker diaphragm; a separation claw such as a separation claw for a copier or a separation claw for a printer; a camera module component; a switch component; a motor component; a sensor component; a hard disk drive component; tableware such as ovenware; a car component; a battery component; an aircraft part; and a sealing member such as a sealing member for a semiconductor element or a sealing member for coil.

Among these, the molded body of the embodiment is preferably a connector and is more preferably a connector obtained by performing the molding by the injection molding method. Here, the connector mainly indicates equipment used for connection between members such as electronic equipment, or a member used at the connected portion of the equipment, and particularly indicates the member used for connection between wires such as cords of electronic equipment.

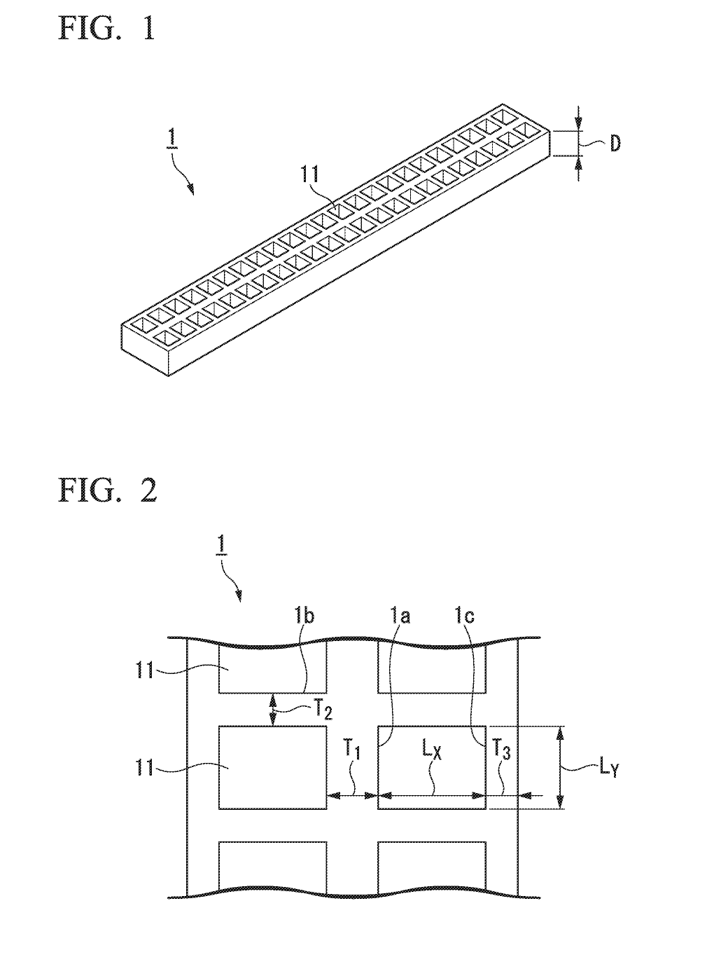

FIG. 1 is a perspective view schematically showing a connector of an aspect of the embodiment and FIG. 2 is an enlarged front view showing main parts of the connector shown in FIG. 1.

A connector 1 shown here has a rectangular shape, and a plurality of terminal insertion ports 11 having square (rectangular) openings are disposed to be arranged in two rows.

A thickness D of the connector 1 is preferably 3 to 50 mm and more preferably 4 to 10 mm.

In the opening of the terminal insertion port 11, a length of a long side is L_{X} and a length of a short side is L_{Y}.

In a short direction of the connector 1, that is, a long side direction of the opening of the terminal insertion port 11, a portion which separates the adjacent terminal insertion ports 11 from each other is a thin wall portion (hereinafter, referred to as a “first thin wall portion”) 1a and a thickness thereof is T₁. In addition, in a longitudinal direction of the connector 1, that is, a short side direction of the opening of the terminal insertion port 11, a portion which separates the adjacent terminal insertion ports 11 from each other is a thin wall portion (hereinafter, referred to as a “second thin wall portion”) 1b and a thickness thereof is T₂. Further, a side wall 1c of the connector 1 which forms a part of the terminal insertion port 11 is also a thin wall portion and a thickness thereof is T₃.

In the connector 1, L_{X} is preferably 0.5 to 3 mm and more preferably 1 to 2 mm. In addition, L_{Y} is preferably 0.3 to 3 mm and more preferably 0.5 to 2 mm.

In the connector 1, T₁ is preferably 0.3 to 3 mm and more preferably 0.5 to 2 mm. In addition, T₂ is preferably 0.1 to 3 mm and more preferably 0.3 to 2 mm. Further, T₃ is preferably 0.1 to 3 mm and more preferably 0.3 to 2 mm.

The connector 1 having such thin wall portions has particularly excellent effect of high bending strength as the molded body.

The connector 1 shown in FIG. 1 is merely an aspect of the embodiment, and the connector of the embodiment is not limited thereto. For example, the terminal insertion ports 11 may not be arranged in two rows, and the shape of the connector may be a shape other than a rectangular shape such as plate shape in accordance with the disposition state of the terminal insertion ports 11.

### EXAMPLES

Hereinafter, the embodiment will be described more specifically with reference to examples. However, the embodiment of the invention is not limited to the examples shown below.

Plate-like inorganic fillers used in the following examples and comparative examples are shown below.

(Plate-Like Inorganic Filler) Plate-like inorganic filler (F1): mica (“A2000” manufactured by Japan Mica Industrial Co., Ltd.)

Plate-like inorganic filler (F2): mica (“YM-25S” manufactured by Yamaguchi Mica Co., Ltd.)

Plate-like inorganic filler (F3): mica (“M-400” manufactured by Repco Co., Ltd.)

Plate-like inorganic filler (F4): mica (“TK-400” manufactured by Tokai Kogyo Co., Ltd.)

Plate-like inorganic filler (F5): mica (“CS-20” manufactured by Seishin Enterprise Co., Ltd.)

The X-ray fluorometry was performed regarding the plate-like inorganic fillers (F1) to (F5) by the following method, and the Fe/Si ratio, the Ti/Si ratio, and the Ca/Si ratio were acquired. The results are shown in Table 1.

<Calculation of Fe/Si Ratio, Ti/Si Ratio, and Ca/Si Ratio of Plate-Like Inorganic Filler>

(Manufacturing of Bead Sample of Plate-Like Inorganic Filler)

300 mg of the plate-like inorganic filler, 6 g of lithium tetraborate, and 10 μL of an aqueous lithium bromide solution having a concentration of 33 mass % were weighed on a platinum crucible, these were heated at 750° C. for 2 minutes, heated at 1150° C. for 3 minutes, and then, heated at 1150° C. for 7 minutes while oscillating, by using a bead sampler (“TK4100” manufactured by Tokyo Chemicals Co., Ltd.), and thus, a solution in which all of the mixed components were dissolved was obtained. Then, by cooling the obtained solution, a bead sample of the plate-like inorganic filler was prepared.

(Manufacturing of Reference Bead Sample) 6 g of lithium tetraborate and 10 μL of an aqueous lithium bromide solution having a concentration of 33 mass % were weighed on a platinum crucible, these were heated at 750° C. for 2 minutes, heated at 1150° C. for 3 minutes, and then, heated at 1150° C. for 7 minutes while oscillating, by using a bead sampler (“TK4100” manufactured by Tokyo Chemicals Co., Ltd.), and thus, a solution in which all of the mixed components were dissolved was obtained. Then, by cooling the obtained solution, a reference bead sample was prepared.

(Measurement of Signal Strength of Silicon in Plate-Like Inorganic Filler by X-Ray Fluorometry)

A collimator mask was set as 27 mm and a collimator was set as 300 μm by using an X-ray fluorescence spectrometer (“MagiX Pro” manufactured by Spectris Co., Ltd.) and an X-ray tube (“4 kW end-on type ruthenium manufactured by Spectris Co., Ltd.) and without using a bulb filter, and the output of the X-ray tube was set as 32 kV/125 mA by using a gas flow counter as a detector and “Pentaerythritol 002” as dispersive crystal. Regarding the bead sample of the plate-like inorganic filler and the reference bead sample described above, signal strengths (unit: kilo count per second) of silicon in a case where 2θ=109.1° were measured. Then, the signal strength of silicon in the reference bead sample was subtracted from the signal strength of silicon in the bead sample of the plate-like inorganic filler to obtain the signal strength of silicon of the plate-like inorganic filler.

(Measurement of Signal Strength of Iron in Plate-Like Inorganic Filler by X-Ray Fluorometry)

A collimator mask was set as 27 mm and a collimator was set as 300 μm by using an X-ray fluorescence spectrometer (“MagiX Pro” manufactured by Spectris Co., Ltd.) and an X-ray tube (“4 kW end-on type ruthenium manufactured by Spectris Co., Ltd.) and without using a bulb filter, and the output of the X-ray tube was set as 60 kV/66 mA by using a gas flow counter as a detector and “LiF 200” as dispersive crystal. Regarding the bead sample of the plate-like inorganic filler and the reference bead sample described above, signal strengths (unit: kilo count per second) of iron in a case where 2θ=57.5° were measured. Then, the signal strength of iron in the reference bead sample was subtracted from the signal strength of iron in the bead sample of the plate-like inorganic filler to obtain the signal strength of iron of the plate-like inorganic filler.

(Measurement of Signal Strength of Titanium in Plate-Like Inorganic Filler by X-Ray Fluorometry)

A collimator mask was set as 27 mm and a collimator was set as 300 μm by using an X-ray fluorescence spectrometer (“MagiX Pro” manufactured by Spectris Co., Ltd.) and an X-ray tube (“4 kW end-on type ruthenium manufactured by Spectris Co., Ltd.) and without using a bulb filter, and the output of the X-ray tube was set as 40 kV/100 mA by using a gas flow counter as a detector and “LiF 200” as dispersive crystal. Regarding the bead sample of the plate-like inorganic filler and the reference bead sample described above, the signal strengths (unit: kilo count per second) of titanium in a case where 2θ=86.1° C. were measured. Then, the signal strength of titanium in the reference bead sample was subtracted from the signal strength of titanium in the bead sample of the plate-like inorganic filler to obtain the signal strength of titanium in the plate-like inorganic filler.

(Measurement of Signal Strength of Calcium in Plate-Like Inorganic Filler by X-Ray Fluorometry)

A collimator mask was set as 27 mm and a collimator was set as 300 μm by using an X-ray fluorescence spectrometer (“MagiX Pro” manufactured by Spectris Co., Ltd.) and an X-ray tube (“4 kW end-on type ruthenium manufactured by Spectris Co., Ltd.) and without using a bulb filter, and the output of the X-ray tube was set as 32 kV/125 mA by using a gas flow counter as a detector and “LiF 200” as dispersive crystal. Regarding the bead sample of the plate-like inorganic filler and the reference bead sample described above, signal strengths (unit: kilo count per second) in a case where 2θ=113.1° were measured. Then, the signal strength of calcium in the reference bead sample was subtracted from the signal strength of calcium in the bead sample of the plate-like inorganic filler to obtain the signal strength of calcium in the plate-like inorganic filler. As a result of the measurement of the signal strength of calcium by this method, the signal strength was determined as “0”, in a case where a negative value is obtained.

(Calculation of Fe/Si Ratio)

The signal strength of iron in the plate-like inorganic filler obtained as described above was divided by the signal strength of silicon in the plate-like inorganic filler obtained as described above to calculate the Fe/Si ratio.

(Calculation of Ti/Si Ratio)

The signal strength of titanium in the plate-like inorganic filler obtained as described above was divided by the signal strength of silicon of the plate-like inorganic filler obtained as described above to calculate the Ti/Si ratio.

(Calculation of Ca/Si Ratio)

The signal strength of calcium in the plate-like inorganic filler obtained as described above was divided by the signal strength of silicon of the plate-like inorganic filler obtained as described above to calculate the Ca/Si ratio.

<Preparation of Liquid Crystal Polyester>

### Preparation Example 1

994.5 g (7.2 mol) of p-hydroxybenzoic acid, 299.0 g (1.8 mol) of terephthalic acid, 99.7 g (0.6 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. in 30 minutes while stirring under a nitrogen gas flow, and reflux was performed at 150° C. for 30 minutes.

Then, 2.4 g of 1-methylimidazole was added thereto, the temperature was increased from 150° C. to 320° C. in 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 250° C. in 1 hour under a nitrogen atmosphere, further heated from 250° C. to 295° C. in 5 hours, held at 295° C. for 3 hours, and the solid phase polymerization is thereby performed. The obtained solid-phase polymer was cooled to room temperature and powder-like liquid crystal polyester (L1) was obtained. The flow start temperature of the liquid crystal polyester (L1) was 327° C.

### Preparation Example 2

994.5 g (7.2 mol) of p-hydroxybenzoic acid, 239.2 g (1.44 mol) of terephthalic acid, 159.5 g (0.96 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. in 30 minutes while stirring under a nitrogen gas flow, and reflux was performed at 150° C. for 30 minutes.

Then, 2.4 g of 1-methylimidazole was added thereto, the temperature was increased from 150° C. to 320° C. for 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 220° C. in 1 hour under a nitrogen atmosphere, further heated from 220° C. to 240° C. in 30 minutes, held at 240° C. for 10 hours, and the solid phase polymerization is thereby performed. The obtained solid-phase polymer was cooled to room temperature and powder-like liquid crystal polyester (L2) was obtained. The flow start temperature of the liquid crystal polyester (L2) was 286° C.

### Preparation Example 3

994.5 g (7.2 mol) of p-hydroxybenzoic acid, 299.0 g (1.8 mol) of terephthalic acid, 99.7 g (0.6 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. for 30 minutes while stirring under a nitrogen gas flow, and reflux was performed at 150° C. for 30 minutes.

Then, the temperature was increased from 150° C. to 320° C. for 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 250° C. in 1 hour under a nitrogen atmosphere, further heated from 250° C. to 295° C. in 5 hours, and held at 295° C. for 3 hours, and the solid phase polymerization is thereby performed. The obtained solid-phase polymer was cooled to room temperature and powder-like liquid crystal polyester (L3) was obtained. The flow start temperature of the liquid crystal polyester (L3) was 327° C.

### Preparation Example 4

994.5 g (7.2 mol) of p-hydroxybenzoic acid, 358.8 g (2.16 mol) of terephthalic acid, 39.9 g (0.24 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. for 30 minutes while stirring under a nitrogen gas flow, and reflux was performed at 150° C. for 30 minutes.

Then, the temperature was increased from 150° C. to 320° C. for 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 250° C. in 1 hour under a nitrogen atmosphere, further heated from 250° C. to 295° C. in 5 hours, held at 295° C. for 3 hours, and the solid phase polymerization is thereby performed. The obtained solid-phase polymer was cooled to room temperature and powder-like liquid crystal polyester (L4) was obtained. The flow start temperature of the liquid crystal polyester (L4) was 360° C.

<Preparation of Liquid Crystal Polyester Composition>

### Examples 1 and 2 and Comparative Examples 1 to 3

The type of liquid crystal polyester and the type of plate-like inorganic filler shown in Table 1 were mixed at the ratio shown in Table 1 by using a Henschel mixer, the mixture obtained by setting a cylinder temperature as 330° C. was granulated by using a twin-screw extruder (“PCM-30 Type” manufactured by Ikegai Corporation), thereby obtaining a pelleted liquid crystal polyester composition.

### Examples 3 and 4 and Comparative Example 4

The type of liquid crystal polyester and the type of plate-like inorganic filler shown in Table 1 were mixed at the ratio shown in Table 1 by using a Henschel mixer, the mixture obtained by setting a cylinder temperature as 360° C. was granulated by using a twin-screw extruder (“PCM-30 Type” manufactured by Ikegai Corporation), thereby obtaining a pelleted liquid crystal polyester composition.

<Preparation and Evaluation of Molded Body>

A molded body was manufactured from the liquid crystal polyester composition obtained in each of the examples and the comparative examples by the following method, and bending strength, heat resistance, and soldering heat resistance were evaluated. The results are shown in Table 1.

(Evaluation of Bending Strength of Molded Body)

A rod-like test piece having a width of 12.7 mm, a length of 127 mm, and a thickness of 6.4 mm was manufactured from the liquid crystal polyester composition as the molded body, by using an injection molding machine (“PS40E5ASE” manufactured by Nissei Plastic Industrial Co., Ltd.) under the conditions of a cylinder temperature of 350° C., a die temperature of 130° C., and an injection rate of 60 mm/sec.

Then, regarding the obtained rod-like test piece, a bending test was performed based on ASTM D790 and bending strength was measured.

(Evaluation of Heat Resistance of Molded Body)

A rod-like test piece having a width of 6.4 mm, a length of 127 mm, and a thickness of 12.7 mm was manufactured from the liquid crystal polyester composition as the molded body, by using an injection molding machine (“PS40E5ASE” manufactured by Nissei Plastic Industrial Co., Ltd.) under the conditions of a cylinder temperature of 350° C., a die temperature of 130° C., and an injection rate of 60 mm/sec.

Then, regarding the obtained rod-like test piece, a deflection temperature under load was measured with a load of 1.82 MPa at a rate of a temperature increase of 2° C./min based on ASTM D648, and the heat resistance was evaluated.

(Evaluation of Soldering Heat Resistance of Molded Body)

A JIS K7113 (½) type dumbbell test pieces (thickness of 1.2 mm) were manufactured from the liquid crystal polyester composition as the molded body, by using an injection molding machine (“PS40E5ASE” manufactured by Nissei Plastic Industrial Co., Ltd.) under the conditions of a cylinder temperature of 350° C., a die temperature of 130° C., and an injection rate of 75 mm/sec.

Then, the 10 dumbbell test pieces obtained were dipped in a solder bath heated to 270° C. for 60 seconds and extracted, surfaces of these 10 test pieces were visually observed, and the number of test pieces having surfaces, where blisters were observed, was counted, to evaluate the soldering heat resistance of the test pieces from the number.

TABLE 1

| | | Example | Example | Example | Example | Comparative | Comparative | Comparative | Comparative |
|---|---|---|---|---|---|---|---|---|---|
| | | 1 | 2 | 3 | 4 | Example 1 | Example 2 | Example 3 | Example 4 |
| Component | Liquid crystal | (L1) 55 | (L1) 55 | (L3) 50 | (L3) 50 | (L1) 55 | (L1) 55 | (L1) 55 | (L3) 50 |
| | polyester | (L2) 45 | (L2) 45 | (L4) 50 | (L4) 50 | (L2) 45 | (L2) 45 | (L2) 45 | (L4) 50 |
| | Parts by mass | | | | | | | | |
| | Plate-like | (F1) 33 | (F2) 33 | (F1) 43 | (F2) 43 | (F3) 33 | (F4) 33 | (F5) 33 | (F5) 43 |
| | inorganic filler | | | | | | | | |
| | Parts by mass | | | | | | | | |
| Plate-like | Fe/Si ratio | 1.453 | 1.665 | 1.453 | 1.665 | 2.913 | 2.739 | 2.838 | 2.838 |
| inorganic | Ti/Si ratio | 0.047 | 0.068 | 0.047 | 0.068 | 0.094 | 0.086 | 0.093 | 0.093 |
| filler | Ca/Si ratio | 0.001 | 0.000 | 0.001 | 0.000 | 0.004 | 0.008 | 0.000 | 0.000 |
| Evaluation | Bending strength | 135 | 143 | 133 | 133 | 116 | 115 | 115 | 116 |
| result of | (MPa) | | | | | | | | |
| molded body | Heat resistance | 235 | 249 | 290 | 292 | 230 | 226 | 228 | 283 |
| | (° C.) | | | | | | | | |
| | Soldering heat | 1 | 2 | 0 | 2 | 8 | 7 | 3 | 2 |
| | resistance | | | | | | | | |
| | (number) | | | | | | | | |

As shown from the results, in Examples 1 to 4, by using the plate-like inorganic filler (F1) or (F2) as the plate-like inorganic filler in the liquid crystal polyester composition, the bending strength of the obtained molded bodies was high. In addition, the molded bodies had high heat resistance and soldering heat resistance and particularly preferable properties as the molded body.

Both of the liquid crystal polyesters (L1) and (L2) and the liquid crystal polyesters (L3) and (L4) are in a relationship of the liquid crystal polyesters (A) and (B) described above, but the liquid crystal polyesters (L3) and (L4) are a more preferable combination than the liquid crystal polyesters (L1) and (L2), and thus, excellent heat resistance of the molded bodies was obtained in Examples 3 and 4, compared to that in Examples 1 and 2.

On the other hand, in Comparative Examples 1 to 4, the bending strength of the obtained molded bodies was low. A more specific description is as follows.

In Comparative Examples 1 to 3, regardless of the usage of the same liquid crystal polyester as that in Examples 1 and 2 in the liquid crystal polyester composition, the bending strength of the obtained molded bodies was deteriorated, compared to that in Examples 1 and 2, by using the plate-like inorganic filler (F3), (F4), or (F5) as the plate-like inorganic filler. In addition, in Comparative Examples 1 to 3, the heat resistance and soldering heat resistance of the molded bodies were also deteriorated, compared to those in Examples 1 and 2.

In Comparative Example 4, regardless of the usage of the same liquid crystal polyester as that in Examples 3 and 4 in the liquid crystal polyester composition, the bending strength and heat resistance of the obtained molded body were deteriorated, compared to that in Examples 3 and 4, by using the plate-like inorganic filler (F5) as the plate-like inorganic filler. However, in Comparative Example 4, heat resistance and soldering resistance of the molded body were more excellent than those in Comparative Examples 1 to 3, and the particularly excellent heat resistance implies that it is due to the selection of a combination of the liquid crystal polyesters (L3) and (L4), rather than the liquid crystal polyesters (L1) and (L2).

<Manufacturing of Connector>

### Example 5

The liquid crystal polyester composition obtained in Example 1 was dried at 120° C. for 12 hours, and injection molding was performed by using an injection molding machine (“PS40E5ASE” manufactured by Nissei Plastic Industrial Co., Ltd.) under the conditions of a cylinder temperature of 350° C. and a die temperature of 130° C., thereby manufacturing the connector shown in FIG. 1. In this connector, D is 6 mm, L_{X} is 1.1 mm, L_{Y} is 0.8 mm, T₁ is 0.8 mm, T₂ is 0.5 mm, and T₃ is 0.4 mm. The obtained connector has excellent bending strength, in the same manner as the molded bodies of Examples 1 to 4.

### INDUSTRIAL APPLICABILITY

The invention can be used for a molded body required to have high bending strength, such as an electric and electronic component, particularly a connector.

### REFERENCE SIGNS LIST

1 connector
11 terminal insertion port
D thickness of connector
L_{X} length of long side of opening of terminal insertion port
L_{Y} length of short side of opening of terminal insertion port
1a first thin wall portion
1b second thin wall portion
1c side wall of connector
T₁ thickness of first thin wall portion
T₂ thickness of second thin wall portion
T₃ thickness of side wall of connector

1. A liquid crystal polyester composition comprising:
liquid crystal polyester; and
a plate-like inorganic filler,
wherein a ratio of signal strength of iron with respect to signal strength of silicon in the plate-like inorganic filler is 1 to 2.5, in a case where a signal of a component included in the plate-like inorganic filler is detected and strength of the signal is acquired for each component by X-ray fluorometry.

2. The liquid crystal polyester composition according to claim 1,
wherein an amount of the plate-like inorganic filler is 10 to 250 parts by mass with respect to 100 parts by mass of an amount of the liquid crystal polyester.

3. The liquid crystal polyester composition according to claim 1,
wherein a ratio of signal strength of titanium with respect to the signal strength of silicon in the plate-like inorganic filler is 0 to 0.08.

4. The liquid crystal polyester composition according to claim 1,
wherein a ratio of signal strength of calcium with respect to the signal strength of silicon in the plate-like inorganic filler is 0 to 0.003.

5. The liquid crystal polyester composition according to claim 1,
wherein the plate-like inorganic filler is mica.

6. The liquid crystal polyester composition according to claim 1,
wherein the liquid crystal polyester includes a repeating unit represented by General Formula (1), a repeating unit represented by General Formula (2), and a repeating unit represented by General Formula (3).
—O—Ar¹—CO— (1)
—CO—Ar²—CO— (2)
—X—Ar³—Y— (3)
[in Formulae (1) to (3), Ar¹ represents a phenylene group, a naphthylene group, or a biphenylylene group, Ar² and Ar³ each independently represent one of the group consisting of a phenylene group, a naphthylene group, a biphenylylene group, and a group represented by General Formula (4), X and Y each independently represent an oxygen atom or an imino group, and one or more hydrogen atoms in the group represented by one of the group consisting of Ar¹, Ar², and Ar³ may be each independently substituted with one of the group consisting of a halogen atom, an alkyl group having 1 to 28 carbon atoms, and an aryl group having 6 to 12 carbon atoms]
—Ar⁴—Z—Ar⁵— (4)
[in Formula (4), Ar⁴ and Ar^{Y} each independently represent a phenylene group or a naphthylene group, and Z represents one of the group consisting of an oxygen atom, a sulfur atom, a carbonyl group, a sulfonyl group, and an alkylidene group having 1 to 28 carbon atoms].

7. A molded body obtained by molding the liquid crystal polyester composition according to claim 1.

8. A connector obtained by molding the liquid crystal polyester composition according to claim 1.
